(19) United States
(12) Patent Application Publication
(10) Pub. No.: US 2017/0208003 A1
(43) Pub. Date: Jul. 20, 2017

(54) CONVERSION APPARATUS AND CONVERSION METHOD

(71) Applicant: FUJITSU LIMITED, Kawasaki-shi (JP)

(72) Inventor: Yoshiyuki Katada, Amagasaki (JP)

(73) Assignee: FUJITSU LIMITED, Kawasaki-shi (JP)

(21) Appl. No.: 15/382,976

(22) Filed: Dec. 19, 2016

(30) Foreign Application Priority Data
Jan. 18, 2016 (JP) 2016-007374

(51) Int. Cl. H04L 12/741; H04L 12/751; H04L 29/12

(52) U.S. Cl. CPC H04L 45/74; H04L 61/2007; H04L 45/02

(57) ABSTRACT

A conversion apparatus includes an acquiring circuit, a generating circuit and an interface. The acquiring circuit is configured to acquire a pseudo IP address to be used as a next hop IP address, when a first instruction for addition of packet forwarding information including, as a packet forwarding destination, a destination IP address and a destination MAC address is received, the first instruction being transmitted from a controller to a switch. The generating circuit is configured to generate a first association between the destination IP address and the pseudo IP address, and a second association between the pseudo IP address and the destination MAC address. The interface is configured to transmit to the switch a second instruction for addition of the first and the second association.

### CROSS-REFERENCE TO RELATED APPLICATION

This application is based upon and claims the benefit of priority of the prior Japanese Patent Application No. 2016-007374, filed on Jan. 18, 2016, the entire contents of which are incorporated herein by reference.

### FIELD

The present invention relates to a conversion apparatus and a conversion method.

### BACKGROUND

FIG. 1 is a diagram illustrating an example of a SDN network. A Software Defined Networking (SDN) network has a network architecture according to which the network can be controlled by software. According to the SDN, building, setting and the like of the network are collectively performed. A SDN network includes a switch 9, and a controller 3 that controls the switch 9. The controller 3 and the switch 9 communicate over a control plane that is separated from a data plane where user data flows.

As one protocol for the control plane, there is OpenFlow. Each switch 9 controls the data plane according to a control signal according to OpenFlow, for example. That is, the switch 9 illustrated in FIG. 1 is a switch that is compatible with OpenFlow.

The switch 9 holds a flow table, and performs processing on the data plane according to the flow table. An entry in the flow table is referred to as a flow entry. Each switch 9 is notified of a flow entry by the controller 3, and sets the flow entry in the flow table.

A message that is used at the time of the controller 3 notifying each switch 9 of a flow entry is referred to as a FlowMod. FIG. 1 illustrates an example of a flow entry, including information about packet forwarding, which is notified to each switch 9 by the controller 3 by FlowMod. Information about packet forwarding is information that is used or that is referred to at the time of packet forwarding. In the following, the information about packet forwarding will be referred to as packet forwarding information.

The flow entry includes items “Match” and “Instruction”. A condition is defined in “Match”. A processing that is performed in a case where the condition that is defined in “Match” is matched is defined in “Instruction”.

In “Match” of the flow entry illustrated in FIG. 1, “OFPXMT_OFB_ETH_TYPE=0x0800” indicates that the value in the type field of an Ethernet (registered trademark) frame is 0x0800(IPv4). “OFPXMT_OFB_IPv4_DST=[destination IP address]” indicates that the destination IP address of a packet is [destination IP address].

“OFPAT_SET_FIELD(Type=OFPXMT_OFB_ETH_SRC, Value=[own MAC address]”) in “Instruction” of the flow entry illustrated in FIG. 1 indicates that the source MAC address of the frame is set as the MAC address that is specified by [own MAC address]. “OFPAT_SET_FIELD(Type=OFPXMT_OFB_ETH_DST, Value=[destination MAC address])” indicates that the destination MAC address of the frame is set as the MAC address that is specified by [destination MAC address]. “OFPAT_OUTPUT(port=[output port number])” indicates that the frame is to be output from a port that is specified by [output port number].

That is, the flow entry illustrated in FIG. 1 indicates that an IPv4 packet whose destination IP address is [destination IP address] is to be output from [output port number], with the source MAC address set as [own MAC address] and the destination MAC address set as [destination MAC address]. Normally, the MAC address of a port, of the switch 9, corresponding to [output port number] in “OFPAT_OUTPUT(port=[output port number])” is specified in [own MAC address] in “OFPAT_SET_FIELD(Type=OFPXMT_OFB_ETH_SRC, Value=[own MAC address])”. The MAC address of the next hop is specified in [destination MAC address] in “OFPAT_SET_FIELD(Type=OFPXMT_OFB_ETH_DST, Value=[destination MAC address])”.

### PATENT DOCUMENT

[Patent document 1] International Publication No. WO 2011/030889

However, in the case where a switch is not compatible with the format of a flow entry which is notified thereto by the controller 3, the switch is not able to interpret the flow entry notified thereto by the controller 3, and is not placed under the control of the controller 3. A switch which is not compatible with the format of a flow entry is a switch (router or the like) not supporting OpenFlow, or a switch that supports OpenFlow but the format of whose table is not compatible with the flow entry of the controller 3, for example. In OpenFlow, the structure of a table used for control, such as the number of flow tables to be used, is dependent on the setting of each equipment, and may be different for the controller and each switch. For example, if the controller 3 is performing control by one flow table, and a switch is performing control by using a plurality of flow tables, the switch is not compatible with the format of the flow entry of the controller 3.

FIG. 2 is a diagram illustrating an example of a packet forwarding process for a switch which is not compatible with the format of the flow entry of the controller 3. A switch 2 is a switch which is not compatible with the format of the flow entry of the controller 3. The switch 2, which is not compatible with OpenFlow, is provided with a routing table and an Address Resolution Protocol (ARP) table.

The routing table is a table containing an association among an IP address (network address), an output port, and an IP address of a next hop. A next hop is network equipment in Layer 3 existing in the same subnet as the switch 2. The ARP table is a table containing an association between an IP address and a MAC address. In the case where the switch 2 is a switch which is compatible with OpenFlow but not with the format of the flow entry of the controller 3, the switch 2 is likely to hold a flow table #0 corresponding to the routing table and a flow table #1 corresponding to the ARP table.

In the case where the switch 2 is to forward a packet, the MAC address of the next hop is used as the destination MAC address to specify the next transit device of the packet at the Layer 2 level.

Accordingly, the packet forwarding process of the switch 2 is as follows. (1) The switch 2 searches through the routing table with the destination IP address of a received packet as the key, and acquires the output port and the IP address of the next hop. (2) The switch 2 searches through the ARP table with the IP address of the next hop as the key, and acquires the MAC address of the next hop as the destination MAC address.

At the time of output from the switch 2, the destination MAC address and the source MAC address of the packet are rewritten to the MAC address of the next hop and the MAC address of the switch 2, respectively.

FIG. 3 is a diagram illustrating an example of a flow entry of the switch 2 which is compatible with OpenFlow but not with the format of the flow entry of the controller 3. In the example illustrated in FIG. 3, the switch 2 holds a flow table #0 corresponding to the routing table, and a flow table #1 corresponding to the ARP table.

An IPv4 packet whose destination IP address is [destination IP address] is defined by “OFPXMT_OFB_ETH_TYPE=0x0800” and “OFPXMT_OFB_IPv4_DST=[destination IP address]” in “Match” in the flow entry in the flow table #0 in FIG. 3. Writing of [next hop IP address] in metadata of the packet is instructed by “Instruction Type=OFPIT_WRITE_METADATA” and “metadata=[next hop IP address]” in “Instruction”. Metadata is a field in “Match”. Reference to the flow table #1 is instructed by “Instruction Type=OFPIT_GOTO_TABLE” and “Table ID=1” in “Instruction”.

A packet having [next hop IP address] set in metadata is defined by “OFPIT OFB METADATA=[next hop IP address]” in “Match” in the flow entry in the flow table #1 in FIG. 3. In “Instruction”, the source MAC address is set as [own MAC address] and the destination MAC address is set as [destination MAC address], and output from the port of [output port number] is instructed.

That is, the flow tables #0, #1 illustrated in FIG. 3 indicate that an IPv4 packet whose destination IP address is [destination IP address] is to be output from [output port number], with the source MAC address set as [own MAC address] and the destination MAC address as [destination MAC address].

When comparing the flow entry of the controller 3 illustrated in FIG. 1 and the flow entry of the switch 2 illustrated in FIG. 3, [destination IP address], [own MAC address], [destination MAC address], and [output port number] are included in the flow entry of the controller 3. However, [next hop IP address] is not included in the flow entry of the controller 3, and is lacking. Accordingly, even if the switch 2 is notified of the flow entry illustrated in FIG. 1 by the controller 3, the switch 2 is not able to acquire the next hop IP address, and to create entries in the flow tables #0, #1.

FIG. 4 is a diagram illustrating examples of a routing table and an ARP table of the switch 2 not supporting OpenFlow. In the case where the switch 2 is a switch which does not support OpenFlow, the switch 2 holds a routing table and an ARP table.

In FIG. 4, entries, in the routing table and the ARP table, used for packet forwarding are illustrated. Entries, in the routing table and the ARP table, used for packet forwarding are linked by the next hop IP address.

When comparing the flow entry of the controller 3 illustrated in FIG. 1, and the flow entries in the routing table and the ARP table of the switch 2 illustrated in FIG. 4, [destination IP address], [destination MAC address], and [output port number] are included in the flow entry of the controller 3. However, [next hop IP address] is not included in the flow entry of the controller 3. Accordingly, the flow entry notified to the switch 2 by the controller 3 is, for the switch 2, lacking in information.

### SUMMARY

A mode of the present invention is a conversion apparatus. The conversion apparatus receives a first instruction, that is being transmitted from a controller to a switch, for addition of packet forwarding information. The switch forwards a packet based on an association between an IP address and a next hop IP address, and an association between an IP address and a MAC address. The packet forwarding information includes, as a packet forwarding destination, a destination IP address and a destination MAC address. The conversion apparatus includes; an acquiring circuit configured to acquire a pseudo IP address to be used as a next hop IP address when the first instruction is received; a generating circuit configured to generate a first association between a destination IP address and the pseudo IP address, and a second association between the pseudo IP address and a destination MAC address; and an interface configured to transmit to the switch a second instruction for addition of the first association and the second association.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an SDN network;

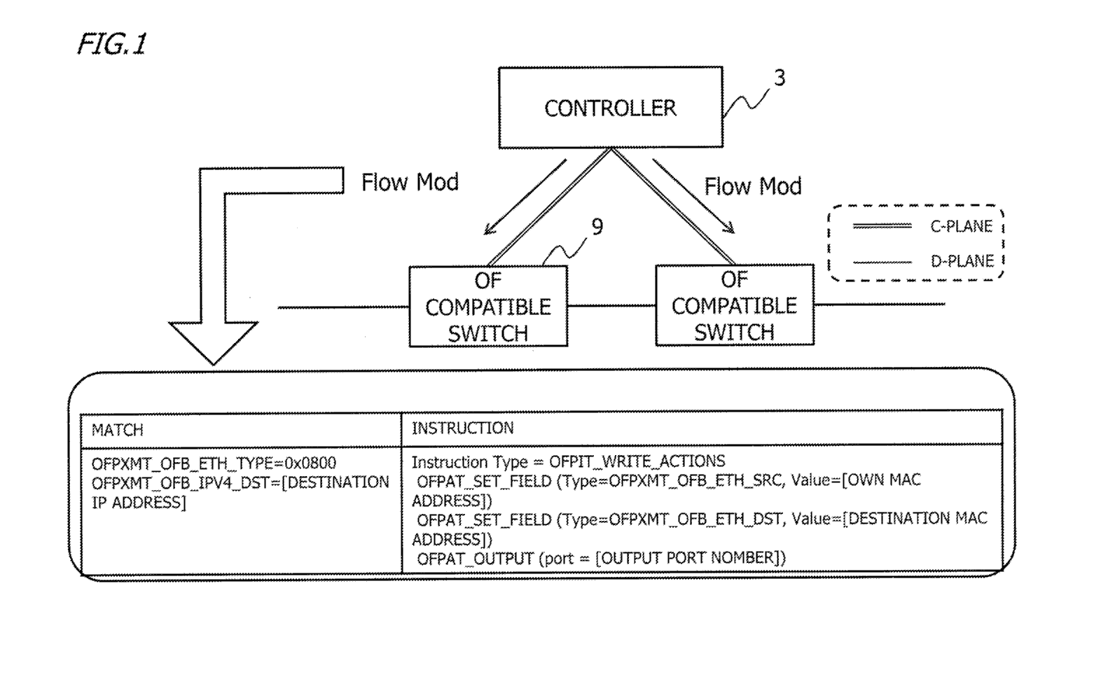

FIG. 2 is a diagram illustrating an example of a packet forwarding process for a switch which is not compatible with the format of a flow entry of a controller;

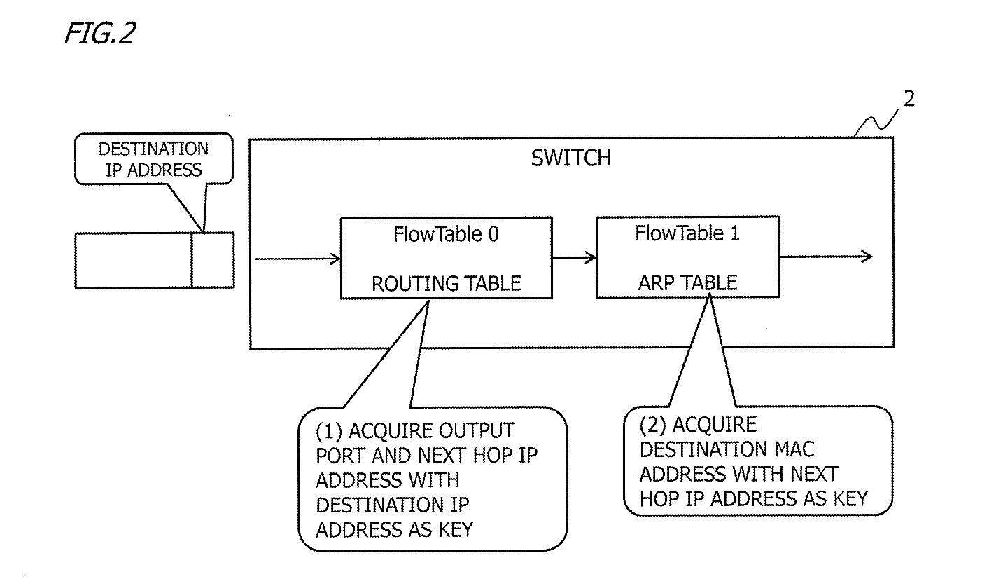

FIG. 3 is a diagram illustrating an example of a flow entry of a switch which is compatible with OpenFlow but not with the format of the flow entry of the controller;

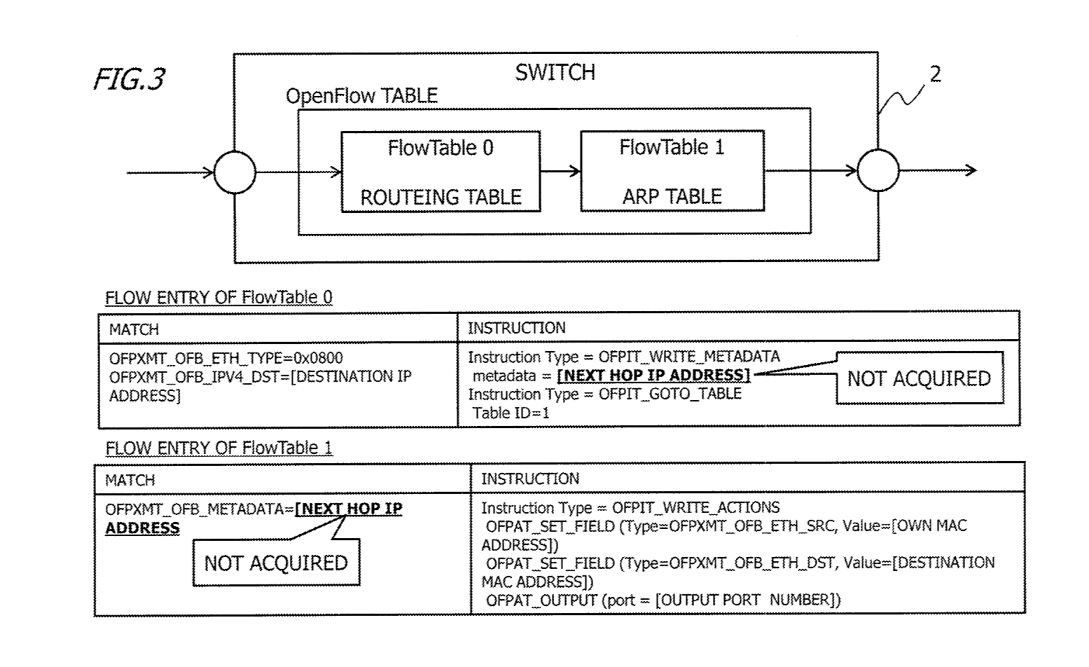

FIG. 4 is a diagram illustrating examples of a routing table and an ARP table of a switch not supporting OpenFlow;

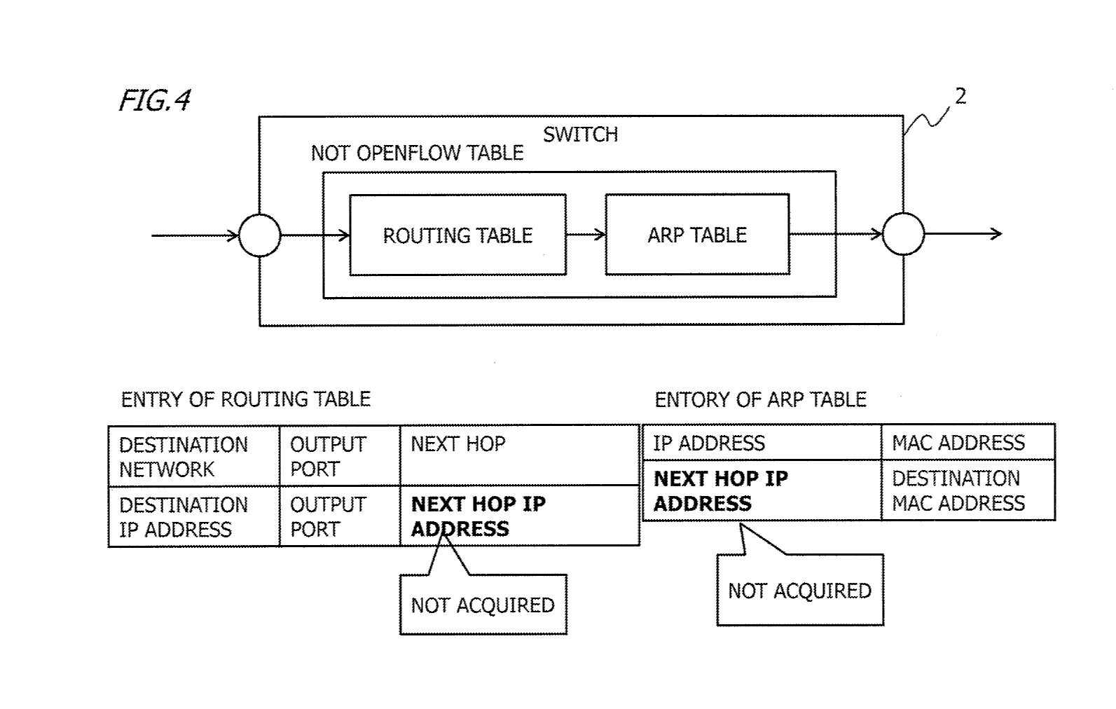

FIG. 5 is a diagram illustrating an example configuration of a communication network according to a first embodiment;

FIG. 6 is a diagram illustrating an example hardware configuration of an OF agent;

FIG. 7 is a diagram illustrating an example of a functional configuration of the OF agent;

FIG. 8A is a process of a control unit for a case where FlowMod information including a flow entry including packet forwarding information is received;

FIG. 8B is a process of the control unit for a case where the FlowMod information including a flow entry including the packet forwarding information is received;

FIG. 9 is an example of a flow chart of a pseudo IP address generating process;

FIG. 10A is a diagram illustrating an example of a sequence of processing at the OF agent;

FIG. 10B is a diagram illustrating an example of a sequence of processing at the OF agent;

FIG. 11 is a diagram illustrating environmental settings according to a specific example;

FIG. 12 is a diagram illustrating an example of a flow entry that is transmitted from a controller to a switch in the specific example;

FIG. 13 is a diagram illustrating an example of a pseudo IP address generating process according to the specific example;

FIG. 14 is a diagram illustrating an example of an entry creating process for a routing table and an ARP table;

FIG. 15 is a diagram illustrating an example of a CLI creating process for case where a switch is not supporting OpenFlow;

FIG. 16 is a diagram illustrating an example of a flow entry creating process for adding an entry in a routing table, for a case where a switch supports OpenFlow but is not compatible with the format of a flow entry of a controller; and

FIG. 17 is a diagram illustrating an example of a flow entry creating process for adding an entry in an ARP table, for a case where a switch supports OpenFlow but is not compatible with the format of a flow entry of a controller.

### DESCRIPTION OF EMBODIMENT

Hereinafter, an embodiment of the present invention will be described with reference to the drawings. The configuration of the embodiment below is merely exemplary, and the present invention is not limited to the configuration of the embodiment.

### First Embodiment

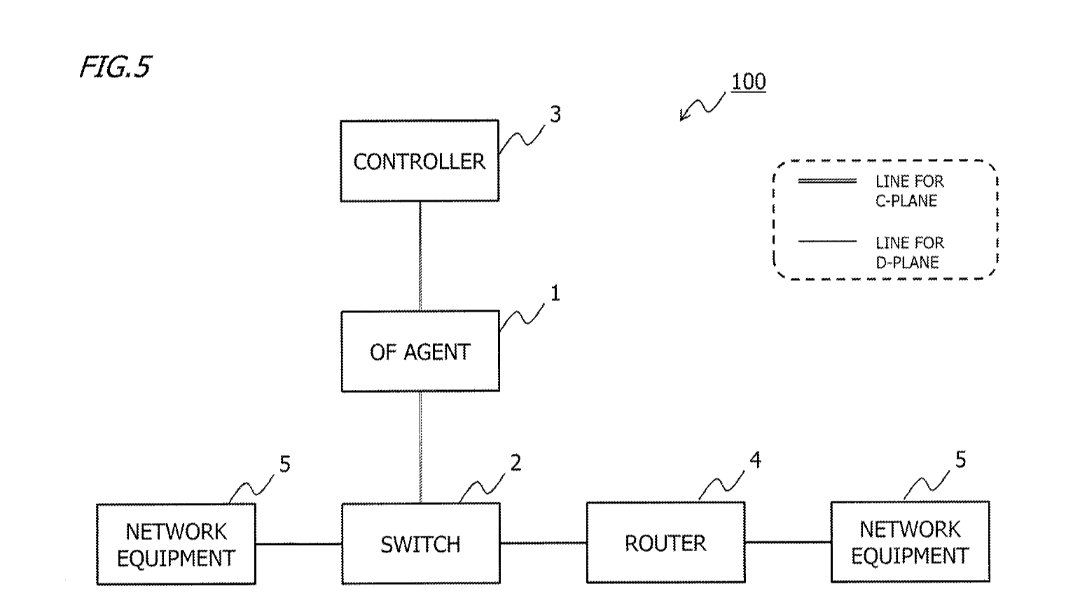

FIG. 5 is a diagram illustrating an example configuration of a communication network according to a first embodiment. A communication network 100 includes an OF agent 1, a switch 2, a controller 3, a router 4, and network equipment 5. The switch 2 is a switch which is not compatible with the format of a flow entry of the controller 3, and which is capable of processing in Layer 3. The switch 2 includes a routing table and an ARP table, or a flow table corresponding to the tables. The router 4 does not support OpenFlow, and is not a control target of the controller 3. The network equipment 5 is a terminal such as a PC, for example. The switch 2, the router 4, and the network equipment 5 are connected on a data plane.

The OF agent 1 exists on a control plane, between the controller 3 and the switch 2, and is connected to the controller 3 and the switch 2. The OF agent 1 converts a flow entry transmitted by the controller 3 to a command line interface (CLI) or a flow entry of a format that can be controlled by the switch 2. As described above, a flow entry, including packet forwarding information, from the controller 3 does not include the IP address of a next hop, and thus, there is a problem that a flow entry or a CLI to be notified to the switch 2, which is not compatible with the format of the flow entry of the controller 3, is not created.

In the first embodiment, in the case where a flow entry including packet forwarding information is received from the controller 3, the OF agent 1 generates a next hop IP address in a pseudo manner. The OF agent 1 generates a flow entry or a CLI to be notified to the switch 2, by using the next hop IP address which has been created in a pseudo manner.

Additionally, in the example illustrated in FIG. 5, the existence of the OF agent 1 is not recognized by the controller 3 and the switch 2. Also, in the first embodiment, the switch 2 and the OF agent 1 are connected in a point-to-point manner.

### Apparatus Configuration

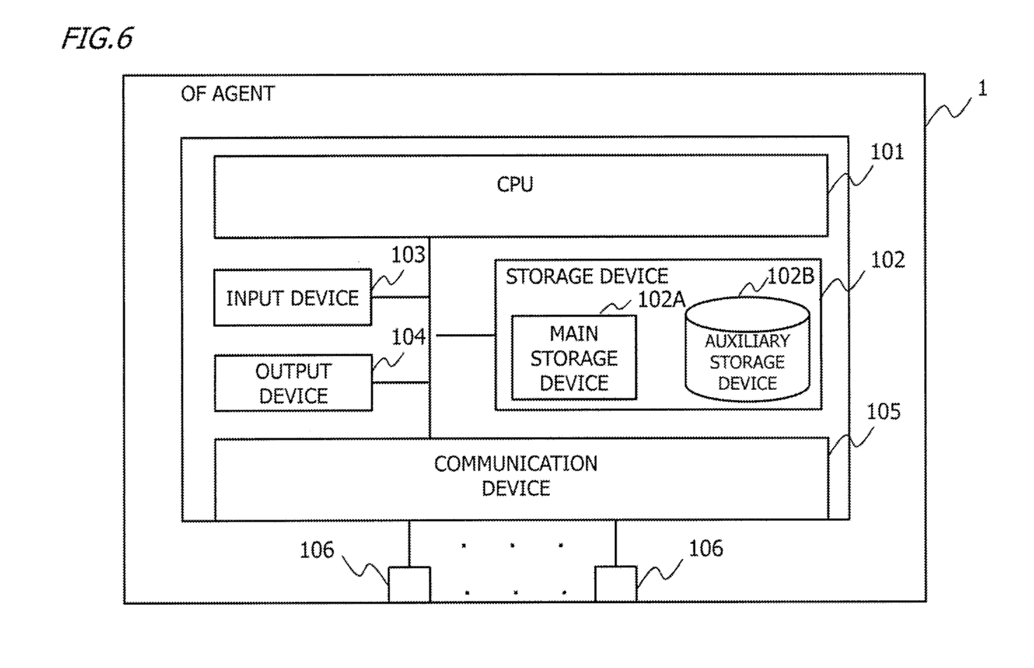

FIG. 6 is a diagram illustrating an example hardware configuration of the OF agent 1. For example, the OF agent 1 is a Layer 2 switch, a Layer 3 switch, a general-purpose computer, or a dedicated computer. In FIG. 6, a hardware configuration is illustrated assuming that the OF agent 1 is a general-purpose computer. The OF agent 1 includes a central processing unit (CPU) 101, a storage device 102, an input device 103, an output device 104, a communication device 105, and a communication port 106. The CPU 101, the storage device 102, the input device 103, the output device 104, and the communication device 105 are electrically connected by a bus. The OF agent 1 is an example of a “conversion apparatus”.

The storage device 102 includes a main storage device 102A and an auxiliary storage device 102B. The main storage device 102 includes a random access memory (RAM), and a read only memory (ROM). The RAM is a semiconductor memory such as a dynamic RAM (DRAM), a static RAM (SRAM), or a synchronous DRAM (SDRAM), for example. The RAM of the main storage device 102A provides the CPU 101 with a storage area or a work area into which programs stored in the ROM and the auxiliary storage device 102B are to be loaded, or is used as a buffer, for example.

For example, the auxiliary storage device 102B stores the operating system (OS), a flow entry conversion program, other application programs, and data that is used by the CPU 101 at the time of execution of each program. For example, the auxiliary storage device 102B is a non-volatile storage medium such as an erasable programmable ROM (EPROM) or a hard disk drive. The flow entry conversion program is a program for converting the flow entry, including packet forwarding information, from the controller 3 to a format enabling control by the switch 2.

The input device 103 includes a keyboard, a pointing device such as a mouse, and the like. Data that is input from the input device 103 is output to the CPU 101.

The CPU 101 performs various processes by loading to the RAM, and executing, the OS or programs stored in the ROM of the main storage device 102A or the auxiliary storage device 102B. There may be a plurality of CPUs 101. The CPU 101 is an example of a “control unit”.

The output device 104 outputs results of processing by the CPU 101. The output device 104 includes a display or a printer.

The communication device 105 is a circuit that is connected to a communication port 106 of a wired network line using an optical line, a local area network (LAN) cable or the like, and that converts an electrical signal input from the communication port 106 into a packet (bit sequence). Additionally, in the first embodiment, the OF agent 1 is connected to the controller 3 and the switch 2 via different communication ports 106.

Additionally, the hardware configuration of the OF agent 1 illustrated in FIG. 6 is an example, and is not limited to the configuration described above, and structural elements may be omitted, substituted, or added as appropriate according to the embodiment. For example, the OF agent 1 may include a removable recording medium drive device, and may use a removable recording medium, such as an SD card, as one of auxiliary storage devices.

Additionally, the switch 2 and the controller 3 have approximately the same hardware configuration as the OF agent 1. The switch 2 is a router, a Layer 3 switch, or an SDN switch, for example. The controller 3 is a dedicated or general-purpose computer, for example. The switch 2 and the controller 3 at least include a CPU, a main storage device, an auxiliary storage device, a communication device, and a communication port. Details of each hardware configuration element are the same as that of the OF agent 1, and description thereof is omitted. The switch 2 is an example of a “switch”. The controller 3 is an example of a “controller”.

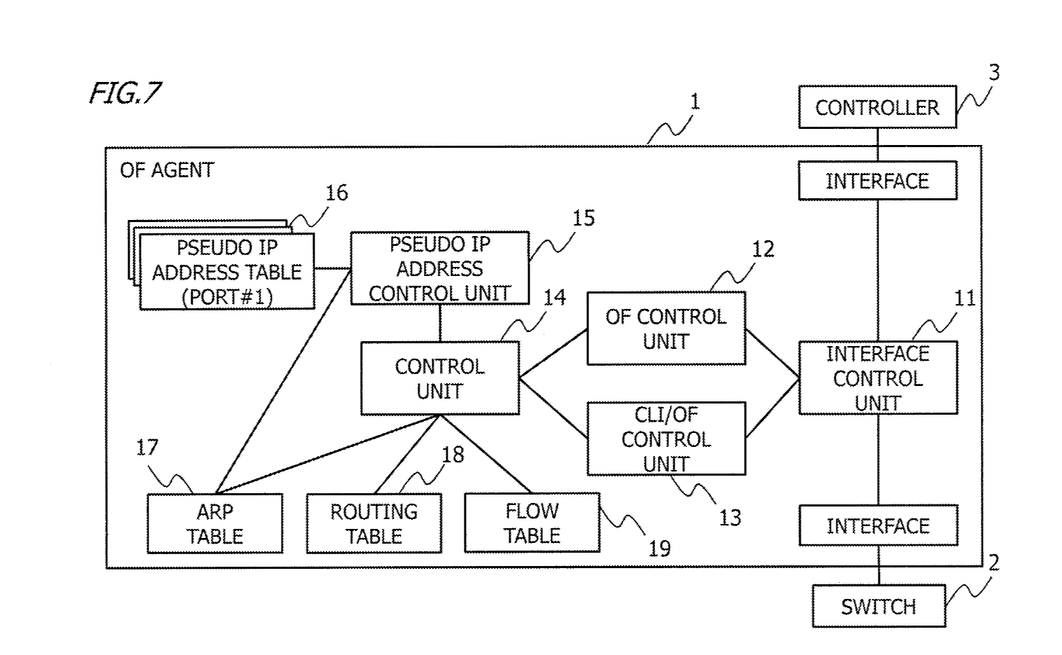

FIG. 7 is a diagram illustrating an example of a functional configuration of the OF agent 1. As the functional configuration, the OF agent 1 includes an interface control unit 11, an OF control unit 12, a CLI/OF control unit 13, a control unit 14, a pseudo IP address control unit 15, a pseudo IP address table 16, an ARP table 17, a routing table 18, and a flow table 19. These are functions that are achieved by the CPU 101 executing the flow entry conversion program stored in the auxiliary storage device 102B.

The interface control unit 11 distributes a packet that is input from the interface to the OF control unit 12 or the CLI/OF control unit 13. In the first embodiment, the OF agent 1 is connected to the controller 3 and the switch 2 via different communication ports 106. For example, the interface control unit 11 acquires an association between each of the OF control unit 12 and the CLI/OF control unit 13, and the interface to be used. The interface control unit 11 outputs packets input from the OF control unit 12 and the CLI/OF control unit 13 to respective associated used interfaces. Also, the interface control unit 11 determines, according to Layer 4 information, for example, to which of the OF control unit 12 and the CLI/OF control unit 13 a packet received by an interface is to be output. The Layer 4 information is a port number of Transmission Control Protocol (TCP)/User Datagram Protocol (UDP), for example.

The OF control unit 12 analyzes an OpenFlow message that is being transmitted from the controller 3 to the switch 2, and outputs the contents of the OpenFlow message to the control unit 14. For example, in the case of a FlowMod which is being transmitted from the controller 3 to the switch 2, the OF control unit 12 extracts a command and a flow entry included in the FlowMod, and outputs the same as FlowMod information to the control unit 14.

Also, in the case where the switch 2 is a switch that is compatible with OpenFlow, contents of an OpenFlow message that is being transmitted from the switch 2 to the controller 3 are input to the OF control unit 12 from the control unit 14. The OF control unit 12 generates an OpenFlow message, including the input contents from the control unit 14, in a format supported by the controller 3, and outputs the message to the interface control unit 11.

The control unit 14 performs a process according to the contents of the OpenFlow message input from the OF control unit 12 or the CLI/OF control unit 13. If the OpenFlow message is the FlowMod being transmitted from the controller 3 to the switch 2, the FlowMod information including a command and a flow entry included in the FlowMod is input to the control unit 14. A command included in the FlowMod may be addition, change or deletion of an entry, for example.

In the case where a command for adding a flow entry and a flow entry including packet forwarding information are included in the FlowMod information notified to the switch 2 by the controller 3, the control unit 14 outputs a pseudo IP address acquisition request to the pseudo IP address control unit 15, and acquires a pseudo IP address. It is determined that the packet forwarding information is included in the flow entry included in the FlowMod information by presence, in the flow entry, of a description “OFPAT_OUTPUT” specifying the output port, for example.

The control unit 14 creates entries for the routing table 18 and the ARP table 17 by using the acquired pseudo IP address. The control unit 14 outputs, to the CLI/OF control unit 13, a request for transmission of the flow entry or CLIs corresponding to the created entries for the routing table 18 and the ARP table 17 to the switch 2.

The control unit 14 manages the ARP table 17, the routing table 18, and the flow table 19. In the case of creating entries for the ARP table 17 and the routing table 18 by using a pseudo IP address, the control unit 14 adds the created entries in the ARP table 17 and the routing table 18. Also, the control unit 14 adds the flow entry included in the FlowMod information to the flow table 19.

The control unit 14 sometimes receives input of FlowMod information, notified by the controller 3 to the switch 2, including a command for deletion of a flow entry and a flow entry including packet forwarding information. In this case, the control unit 14 deletes the corresponding entry in each of the ARP table 17, the routing table 18, and the flow table 19. Also, the control unit 14 outputs, to the CLI/OF control unit 13, a deletion request for deletion target entries in the ARP table 17 and the routing table 18. Also, the control unit 14 notifies the pseudo IP address control unit 15 of a release request for a pseudo IP address which is no longer used due to deletion of the entry in the ARP table 17.

However, with respect to an entry in the ARP table 17, in the case where an entry with the same pseudo IP address as that of the deletion target entry is present in the routing table 18, the entry in the ARP table 17 is not deleted.

The pseudo IP address control unit 15 acquires a pseudo IP address according to the pseudo IP address acquisition request from the control unit 14. A pseudo IP address is an insubstantial IP address which is assumed to be, and used as, the IP address of the next hop. IP addresses that can be used as the pseudo IP address are pooled in the pseudo IP address table 16 for each port of the switch 2. This is because the switch 2 is a device in Layer 3 or higher, and the network address is different for each port. The pseudo IP address control unit 15 selects an unused pseudo IP address from the pseudo IP address table 16 corresponding to a request target port, and notifies the control unit 14 of the pseudo IP address.

The CLI/OF control unit 13 generates a CLI or a flow entry to be notified to the switch 2, in response to a request input from the control unit 14, and outputs the CLI or the flow entry to the interface control unit 11. The CLI/OF control unit 13 holds in advance the format of the CLI or the flow entry to be notified to the switch 2, and generates a CLI or a flow entry to be notified to the switch 2 by embedding information from the control unit 14 in the format.

Also, in the case where the switch 2 is compatible with OpenFlow, an OpenFlow message which is being transmitted from the switch 2 to the controller 3 is input to the CLI/OF control unit 13 from the interface control unit 11. The CLI/OF control unit 13 analyzes the OpenFlow message transmitted from the switch 2, and outputs the contents of the OpenFlow message to the control unit 14. The control unit 14 performs a process according to the contents input from the CLI/OF control unit 13, and outputs a processing result to the OF control unit 12.

The pseudo IP address table 16 may be stored in either of the main storage device 102A and the auxiliary storage device 102B. The pseudo IP address table 16 is created for each port of the switch 2. The pseudo IP address table 16 includes, in an entry, an IP address that is not used by other devices, and the use state of the IP address. The use state of an IP address includes “unused” and “used”, for example. When an IP address in the pseudo IP address table 16 is selected as a pseudo IP address, the use state of the selected IP address is changed by the pseudo IP address control unit 15 from “unused” to “used”. When the IP address in the pseudo IP address table 16 is no longer used as the pseudo IP address, the use state of the IP address is changed by the pseudo IP address control unit 15 from “used” to “unused”. The pseudo IP address table 16 is an example of a “storage unit”.

The ARP table 17, the routing table 18, and the flow table 19 may be stored in either of the main storage device 102A and the auxiliary storage device 102B. The ARP table 17 holds an association between an IP address and a MAC address. The routing table 18 holds an association among an IP address, an output port, and a next hop IP address. The IP address in the ARP table 17 and the next hop IP address in the routing table 18 are pseudo IP addresses. The flow table 19 holds a flow entry.

The ARP table 17, the routing table 18, and the flow table 19 have the same structures as those held by the switch 2, and are created and updated according to a flow entry from the controller 3. As a result, the contents of the ARP table 17, the routing table 18, and the flow table 19 are the same as the contents of the ARP table, the routing table, and the flow table of the switch 2. The ARP table 17 is an example of a “second storage unit”. The routing table 18 is an example of a “first storage unit”.

### Flow of Process

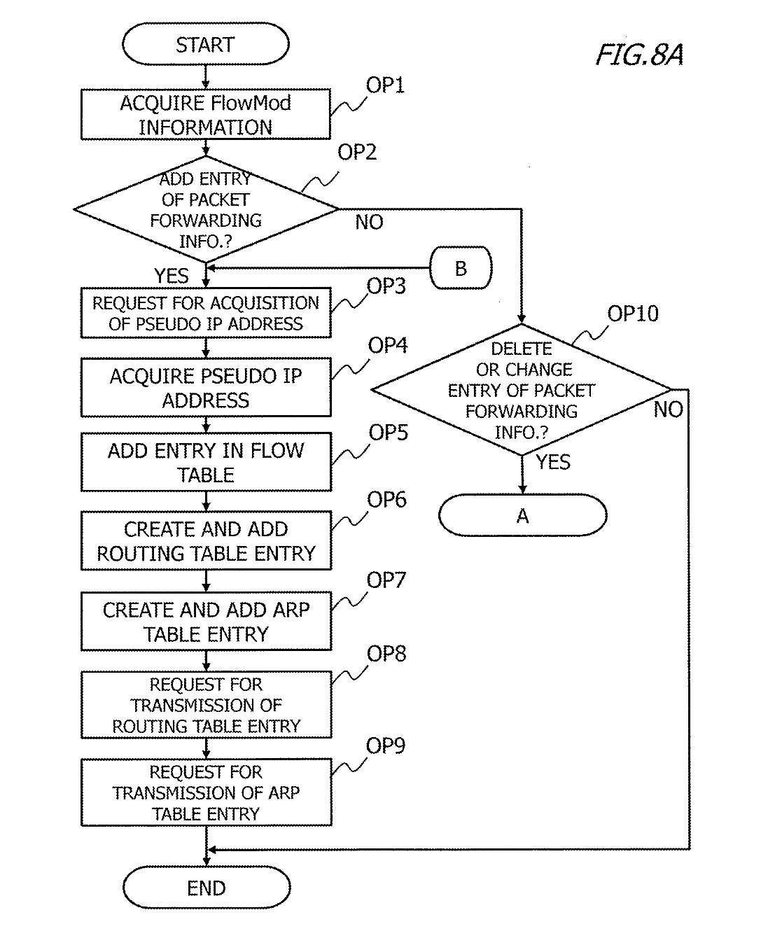

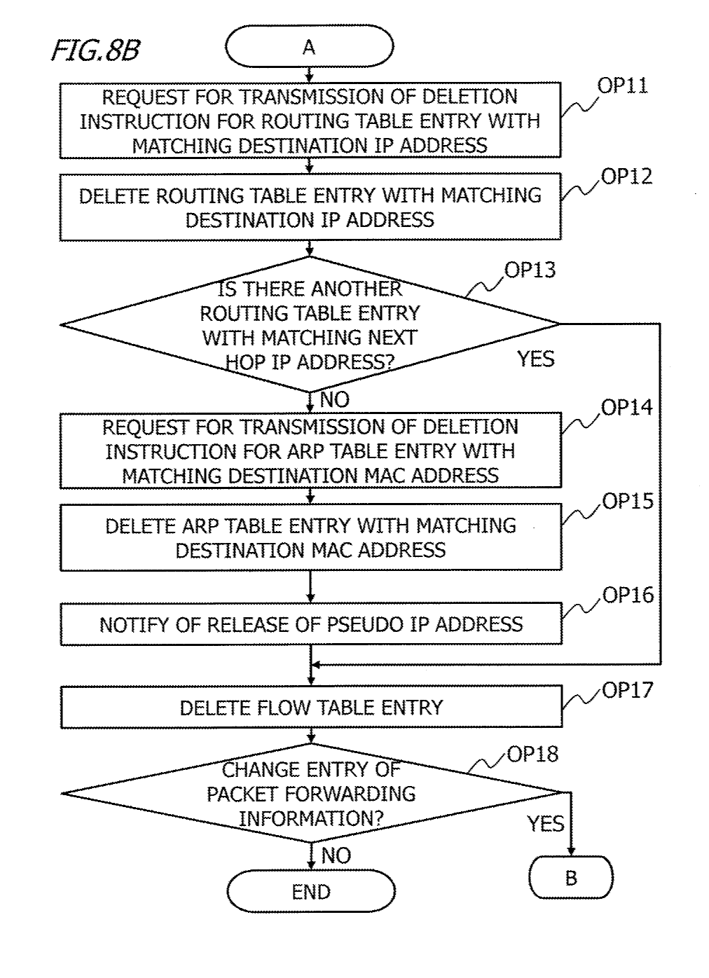

FIGS. 8A and 8B are processes of the control unit 14 for a case where FlowMod information including a flow entry including packet forwarding information is received. The process illustrated in FIG. 8A is started when FlowMod information is input to the control unit 14 from the OF control unit 12. Additionally, the processes illustrated in FIGS. 8A and 8B are mainly performed by the CPU 101 executing the flow entry conversion program, but are described to be mainly performed by the control unit 14, which is one of the functional elements, for the sake of convenience.

In OP1, the control unit 14 acquires FlowMod information. In OP2, the control unit 14 determines whether the FlowMod information includes a command for addition and a flow entry including packet forwarding information. In the case where the FlowMod includes a command for addition and a flow entry including packet forwarding information (OP2: YES), the process proceeds to OP3. In the case where the FlowMod information does not include a command for addition and a flow entry including packet forwarding information (OP2: NO), the process proceeds to OP10. A FlowMod including a command for addition and a flow entry including packet forwarding information is an example of an “instruction for addition”.

In OP3, the control unit 14 outputs a pseudo IP address acquisition request to the pseudo IP address control unit 15. In OP4, the control unit 14 acquires a pseudo IP address from the pseudo IP address control unit 15.

In OP5, the control unit 14 adds the flow entry included in the FlowMod information in the flow table 19.

In OP6, the control unit 14 creates an entry for the routing table 18 from the flow entry included in the FlowMod information and the pseudo IP address, and adds the entry in the routing table 18. The entry added in the routing table 18 is an association among a destination IP address included in the flow entry, an output port included in the flow entry, and the pseudo IP address as a next hop IP address, for example. The entry for the routing table 18 created in OP6 is an example of a “first association”.

In OP7, the control unit 14 creates an entry for the ARP table 17 from the flow entry included in the FlowMod information and the pseudo IP address, and adds the entry in the ARP table 17. The entry added in the ARP table 17 is an association between the pseudo IP address and a destination MAC address included in the flow entry, for example. The entry for the ARP table 17 created in OP7 is an example of a “second association”.

In OP8, the control unit 14 outputs, to the CLI/OF control unit 13, a transmission request for the entry added in the routing table 18 in OP6. In OP9, the control unit 14 outputs, to the CLI/OF control unit 13, a transmission request for the entry added in the ARP table 17 in OP7. Accordingly, CLIs or flow entries corresponding to the entries in the routing table 18 and the ARP table 17 are created by the CLI/OF control unit 13, and are notified to the switch 2. Then, the process illustrated in FIG. 8A is ended.

In OP10, the control unit 14 determines whether the FlowMod information includes a command for deletion or change and a flow entry including packet forwarding information. In the case where the FlowMod information includes a command for deletion or change and a flow entry including packet forwarding information (OP10: YES), the process proceeds to OP11 in FIG. 8B. In the case where the FlowMod information does not include a command for deletion or change and a flow entry including packet forwarding information (OP10: NO), the control unit 14 performs a process according to the contents of the FlowMod information, and the process illustrated in FIG. 8A is ended.

The process illustrated in FIG. 8B is a process for a case where the FlowMod information includes a command for deletion or change and a flow entry including packet forwarding information. In OP11, the control unit 14 specifies an entry, in the routing table 18, which is the target of deletion or change, and outputs a transmission request for a deletion instruction regarding the entry to the CLI/OF control unit 13. In OP12, the control unit 14 deletes the entry from the routing table 18. The entry, in the routing table 18, which is the deletion target is an entry whose IP address matches the address specified as the destination IP address in the flow entry included in the FlowMod information.

In OP13, the control unit 14 determines whether there is an entry in which the same pseudo IP address as in the entry, in the routing table 18, deleted in OP12 is used as the next hop IP address. In the case where there is no entry that uses, as the next hop IP address, the same pseudo IP address as the deleted entry in the routing table 18 (OP13: NO), the process proceeds to OP14.

In the case where there is an entry that uses, as the next hop IP address, the same pseudo IP address as the deleted entry in the routing table 18 (OP13: YES), the process proceeds to OP17. This is because, in this case, deletion of the entry in the ARP table 17 regarding the pseudo IP address is not allowed.

In OP14, the control unit 14 specifies an entry, in the ARP table 17, which is the target of deletion or change, and outputs a transmission request for a deletion instruction regarding the entry to the CLI/OF control unit 13. In OP15, the control unit 14 deletes the entry from the ARP table 17. The entry, in the ARP table 17, which is the deletion target is an entry whose IP address matches the pseudo IP address which is used as the next hop IP address in the entry, in the routing table 18, deleted in OP12. Alternatively, the entry, in the ARP table 17, which is the deletion target is an entry, in the flow entry included in the FlowMod information, including the MAC address which is specified as the destination MAC address.

In OP16, because the pseudo IP address included in the entry, in the ARP table 17, which is deleted in OP15 is no longer used, the control unit 14 outputs a release request for the pseudo IP address to the pseudo IP address control unit 15. When the release request for the pseudo IP address is received, the pseudo IP address control unit 15 changes the use state of the pseudo IP address from “used” to “unused”.

In OP17, the control unit 14 deletes the flow entry matching the flow entry included in the FlowMod information from the flow table 19.

In OP18, the control unit 14 determines whether the command included in the FlowMod information is for change. In the case where the command include in the FlowMod information is for change (OP18: YES), the process proceeds to OP3 in FIG. 8A. In the case where the command included in the FlowMod is not for change, that is, in the case where the command is for deletion (OP18: NO), the process illustrated in FIG. 8B is ended.

The processes illustrated in FIGS. 8A and 8B are merely exemplary, and the order of execution of the processes may be switched as appropriate. For example, OP5, OP6, and OP7 in FIG. 8A may be performed in any order. For example, the order of OP7 and OP8 in FIG. 8A may be switched. For example, the execution order of the processes in OP11 and OP12 in FIG. 8B may be switched. For example, the execution order of OP14 and OP15 in FIG. 8B may be switched.

Additionally, in the processes in FIGS. 8A and 8B, if the command included in the FlowMod information is for change, the processes for addition of a flow entry (FIG. 8A, OP3 to OP9) are performed after the processes for deletion of a flow entry (FIG. 8B, OP11 to OP17). However, the processes for a case where the command included in the FlowMod information is for change are not limited thereto. Depending on the specifications of the switch 2, the control unit 14 may output, to the CLI/OF control unit 13, an ARP table entry change instruction transmission request or a routing table entry change instruction transmission request so that the flow entry is directly changed without being deleted.

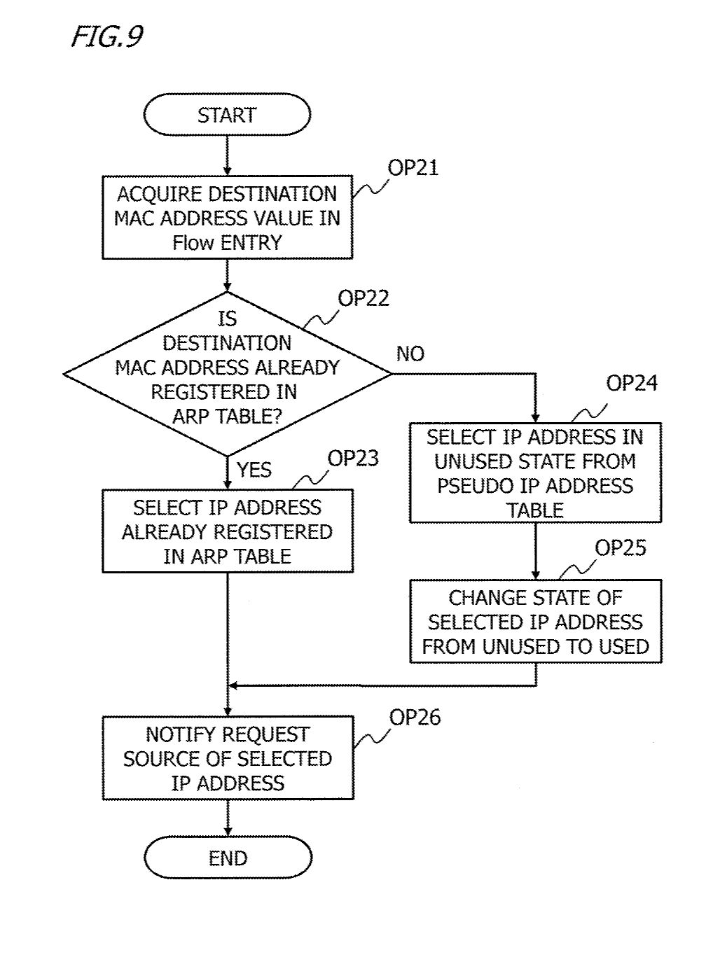

FIG. 9 is an example of a flow chart of a pseudo IP address generation process. The process illustrated in FIG. 9 is started when a pseudo IP address acquisition request is input from the control unit 14 to the pseudo IP address control unit 15 (for example, OP3 in FIG. 8A). Additionally, the process illustrated in FIG. 9 is mainly performed by the CPU 101 executing the flow entry conversion program, but is described to be mainly performed by the pseudo IP address control unit 15, which is one of the functional elements, for the sake of convenience.

In OP21, the pseudo IP address control unit 15 acquires the value in [destination MAC address] in a flow entry included in FlowMod information.

In OP22, the pseudo IP address control unit 15 searches through the ARP table 17 with the acquired destination MAC address as the key, and determines whether the acquired destination MAC address is already registered in the ARP table 17. In the case where the acquired destination MAC address is already registered in the ARP table 17 (OP22: YES), the process proceeds to OP23. In the case where the acquired destination MAC address is not registered in the ARP table 17 (OP22: NO), the process proceeds to OP24.

The process in OP23 is a process for a case where the destination MAC address in the flow entry is already registered in the ARP table 17. In OP23, the pseudo IP address control unit 15 selects, as a pseudo IP address, an IP address that is registered in the ARP table 17 in association with the destination MAC address.

The processes in OP24 and OP25 are processes for a case where the destination MAC address in the flow entry is not registered in the ARP table 17. In OP24, the pseudo IP address control unit 15 selects, as a pseudo IP address, an unused IP address in the pseudo IP address table 16 corresponding to the output port in the flow entry.

In OP25, the pseudo IP address control unit 15 changes the use state of the selected IP address from “unused” to “used”.

In OP26, the pseudo IP address control unit 15 notifies the control unit 14, which is the request source, of the IP address selected as a pseudo IP address. Then, the process illustrated in FIG. 9 is ended.

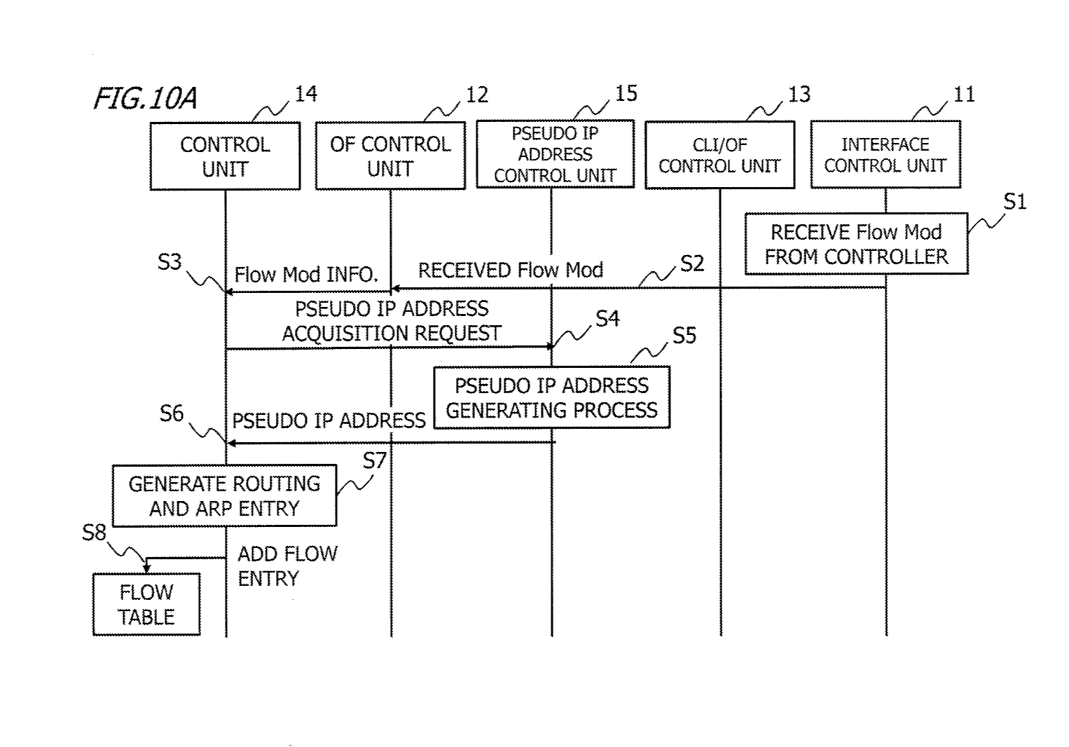

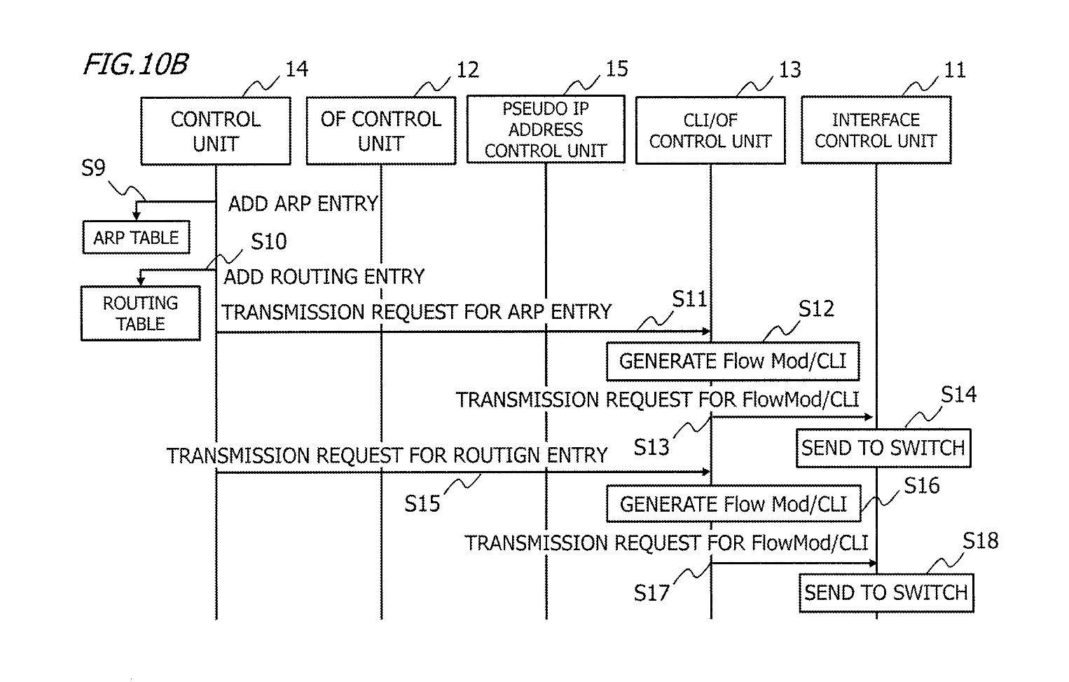

FIGS. 10A and 10B are diagrams illustrating an example of a sequence of processing at the OF agent 1. FIGS. 10A and 10B illustrate a process up to conversion of a flow entry included in a FlowMod being transmitted from the controller 3 to the switch 2 to a format that can be controlled by the switch 2, and transmission of the flow entry. Additionally, it is assumed that, in OF agent 1, the ARP table 17, the routing table 18, and the flow table 19 are all empty.

In S1, the interface control unit 11 receives a FlowMod being transmitted from the controller 3 to the switch 2, from an interface that is connected to the controller 3. The FlowMod received in S1 is assumed to include a command for addition of a flow entry and a flow entry including packet forwarding information.

In S2, the interface control unit 11 outputs the received FlowMod to the OF control unit 12.

In S3, the OF control unit 12 extracts the command and the flow entry from the received FlowMod, and outputs the same to the control unit 14 as FlowMod information.

In S4, the control unit 14 receives the FlowMod information (FIG. 8A, OP1), and because a command for addition and the flow entry for packet forwarding information are included (FIG. 8A, OP2: YES), a pseudo IP address acquisition request is transmitted to the pseudo IP address control unit 15.

In S5, the pseudo IP address control unit 15 selects a pseudo IP address from the pseudo IP address table 16 (FIGS. 9, OP21 to OP24). In S6, the pseudo IP address control unit 15 notifies the control unit 14 of the pseudo IP address (FIG. 9, OP26).

In S7, the control unit 14 creates entries for the routing table 18 and the ARP table 17 based on the flow entry included in the FlowMod information and the pseudo IP address (FIG. 8A, OP6, OP7).

In S8, the control unit 14 adds the flow entry included in the FlowMod information in the flow table 19 (FIG. 8A, OP5). In S9 in FIG. 10B, the control unit 14 adds the entry created for the ARP table 17 in the ARP table 17 (FIG. 8A, OP7). In S10, the control unit 14 adds the entry created for the routing table 18 in the routing table 18 (FIG. 8A, OP6).

In S11, the control unit 14 notifies the CLI/OF control unit 13 of a transmission request for a CLI or a flow entry corresponding to the entry in the ARP table (FIG. 8A, OP9).

In S12, the CLI/OF control unit 13 creates a CLI or a flow entry (FlowMod) of a format that can be controlled by the switch 2, for the entry in the ARP table 17 from the control unit 14. In S13, the CLI/OF control unit 13 outputs a transmission request for the created CLI or FlowMod to the interface control unit 11. In S14, the interface control unit 11 outputs the CLI or FlowMod created by the CLI/OF control unit 13 from the interface connected to the switch 2.

In S15, the control unit 14 notifies the CLI/OF control unit 13 of a transmission request for a CLI or a flow entry corresponding to the entry in the routing table (FIG. 8A, OP8). In S16, the CLI/OF control unit 13 creates a CLI or a flow entry (FlowMod) of a format that can be controlled by the switch 2, for the entry in the routing table 18 from the control unit 14. In S17, the CLI/OF control unit 13 outputs a transmission request for the created CLI or FlowMod to the interface control unit 11. In S18, the interface control unit 11 outputs the CLI or FlowMod created by the CLI/OF control unit 13 from the interface connected to the switch 2. The CLI or FlowMod transmitted to the switch 2 is an example of an “instruction for addition of the first and the second associations”.

### Specific Example

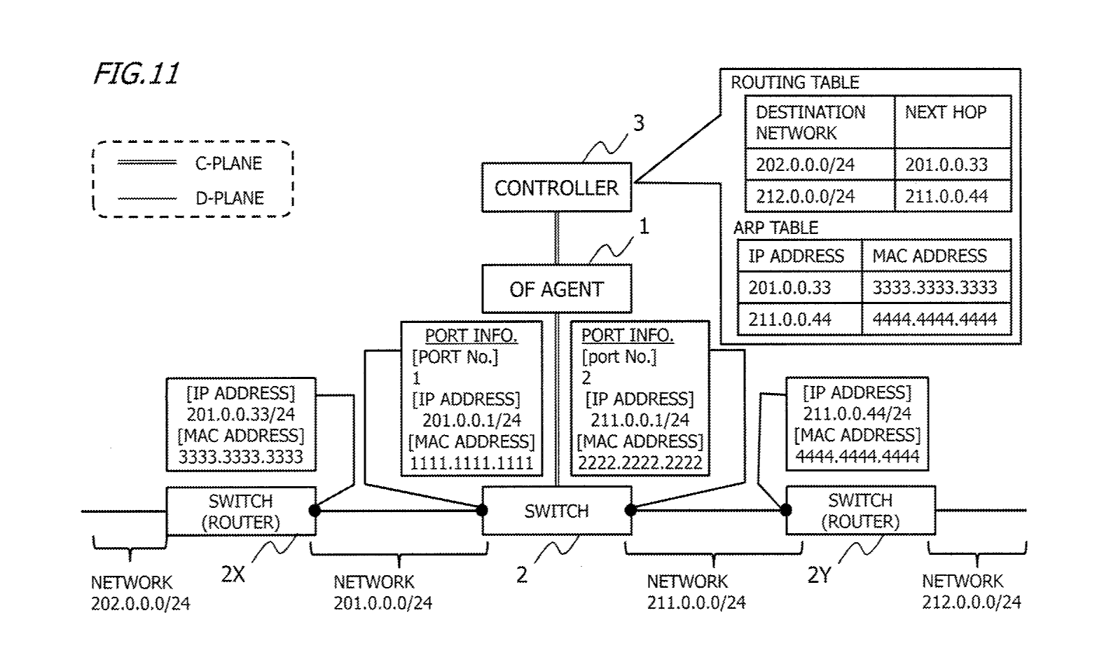

FIG. 11 is a diagram illustrating environmental settings according to a specific example. In FIG. 11, the switch 2 is assumed to be a switch which is not compatible with the format of a flow entry from the controller 3. FIG. 11 illustrates setting information of each port of the switch 2, the routing table and the ARP table (excerpts) of the controller 3, setting information of switches 2X and 2Y which are next hops of the switch 2, and the network address of each subnet.

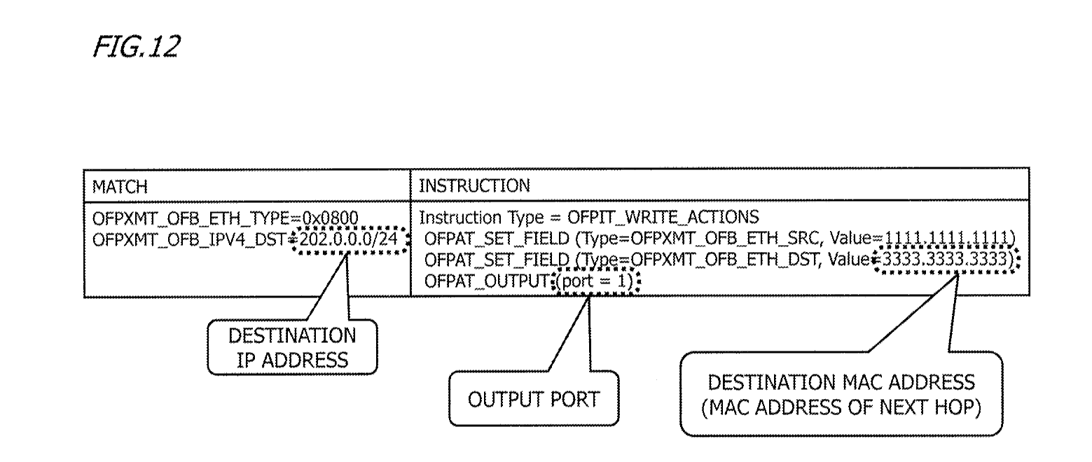

FIG. 12 is a diagram illustrating an example of a flow entry that is transmitted from the controller 3 to the switch 2 in the specific example. In the example illustrated in FIG. 12, [destination IP address] is set to 202.0.0.0/24. The address 202.0.0.0/24 is the network address of a subnet that is connected after the next hop switch 2X (see FIG. 11).

In the example illustrated in FIG. 12, [destination MAC address] is set to 3333.3333.3333. The MAC address 3333.3333.3333 is the MAC address of a port, of the next hop switch 2X, connected to the switch 2 (see FIG. 11). In the example illustrated in FIG. 12, a port #1 is specified as [output port].

That is, the flow entry illustrated in FIG. 12 is for forwarding a packet destined for the subnet at 202.0.0.0/24 in the direction of the router 2X. In the following, in the specific example, there is no entry in the ARP table 17 of the OF agent 1 with the MAC address 3333.3333.3333.

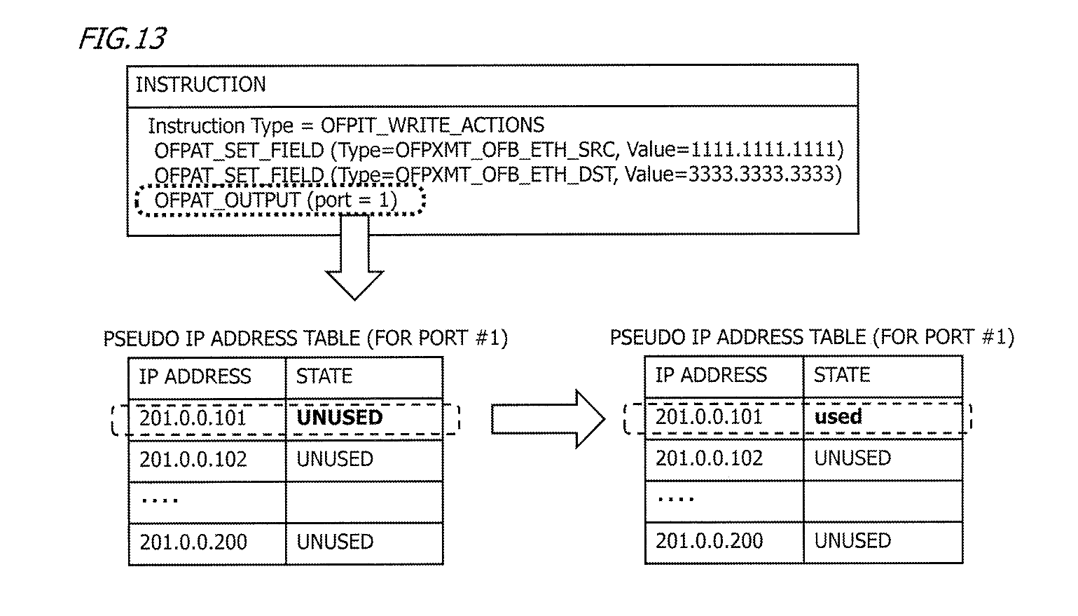

FIG. 13 is a diagram illustrating an example of a pseudo IP address generating process according to the specific example. Because the port #1 is specified in [output port] by the flow entry, the pseudo IP address control unit 15 refers to the pseudo IP address table 16 of the port #1. The pseudo IP address control unit 15 selects an IP address 201.0.0.101, whose use state is “unused”, from the pseudo IP address table 16 of the port #1 (FIG. 9, OP24). The pseudo IP address control unit 15 changes the use state of the IP address 201.0.0.101 in the pseudo IP address table 16 of the port #1 to “used” (FIG. 9, OP25).

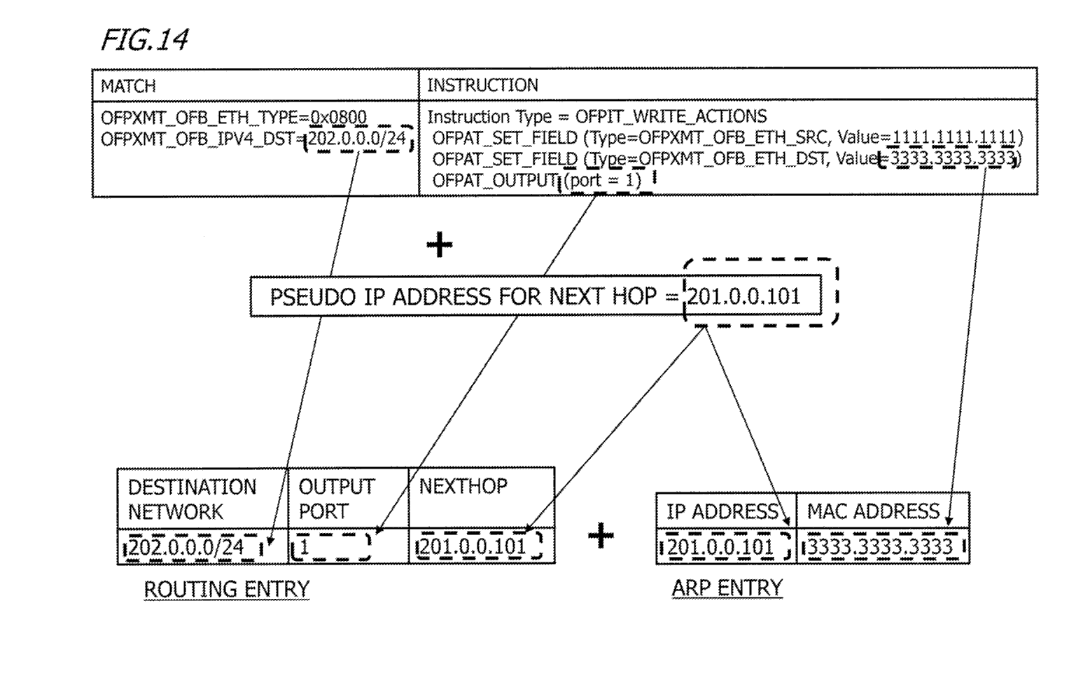

FIG. 14 is a diagram illustrating an example of an entry creating process for the routing table 18 and the ARP table 17. The control unit 14 creates entries for the routing table 18 and the ARP table 17 from the flow entry and the pseudo IP address (FIG. 8A, OP6, OP7).

The entry for the routing table 18 is created by associating the values set in [destination IP address] and [output port] acquired from the flow entry, and the pseudo IP address as the IP address of the next hop. In the example illustrated in FIG. 14, for the entry created for the routing table 18, the destination network is 202.0.0.0/24, the output port is the port #1, and the next hop IP address is 201.0.0.101 (pseudo IP address).

The entry for the ARP table 17 is created by associating the pseudo IP address, and the value in [destination MAC address] acquired from the flow entry. In the example illustrated in FIG. 14, for the entry created for the ARP table 17, the IP address is 201.0.0.101 (pseudo IP address), and the MAC address is 3333.3333.3333. The control unit 14 outputs the created entries of the routing table 18 and the ARP table 17 to the CLI/OF control unit 13.

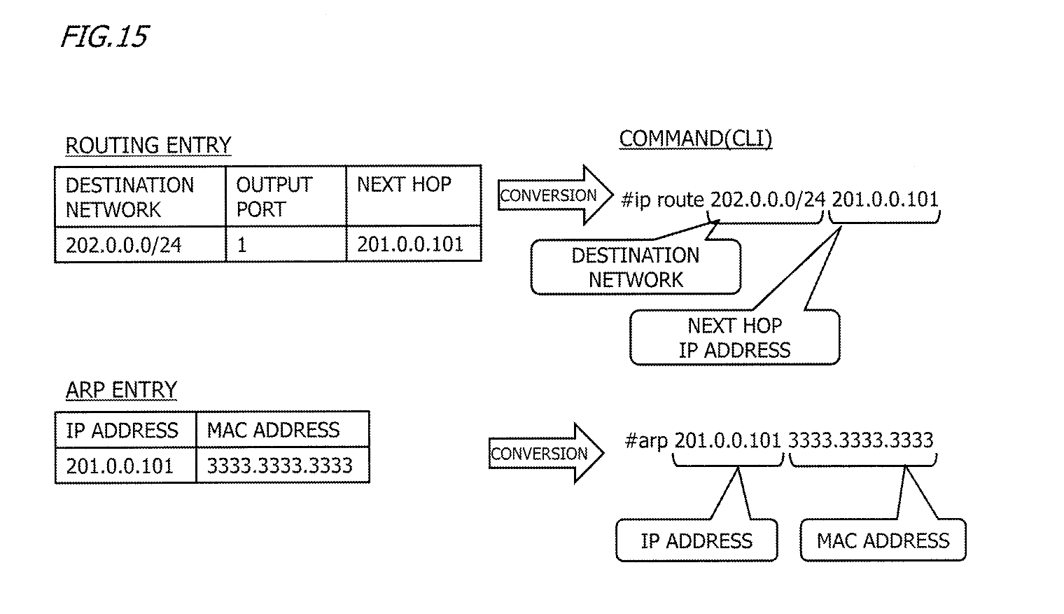

FIG. 15 is a diagram illustrating an example of a CLI creating process for a case where the switch 2 is not supporting OpenFlow. The CLI/OF control unit 13 creates CLIs to be notified to the switch 2 from entries in the routing table 18 and the ARP table 17 (FIG. 10B, S12, S16).

The format of a CLI for adding an entry in the routing table is “#ip route [destination IP address] [next hop IP address] [output port]”, for example. The format of a CLI for adding an entry in the ARP table is “#arp [next hop IP address] [destination MAC address]”, for example. The CLI/OF control unit 13 holds these CLI formats, and creates CLIs by setting values in predetermined positions in the CLI formats.

The value 202.0.0.0/24 of the destination network of the entry created for the routing table 18 is set in [destination IP address] in “#ip route [destination IP address] [next hop IP address] [output port]”. The value 201.0.0.101 of the next hop IP address of the entry created for the routing table 18 is set in [next hop IP address]. Specification of [output port] may be omitted, and is thus not illustrated in FIG. 15. In the case where specification of [output port] is omitted, the switch 2 refers to the IP address of the next hop, and automatically selects an interface having the same network address as the transmission source.

The value 201.0.0.101 of the IP address in the entry created for the ARP table 17 is set in [next hop IP address] in “#arp [next hop IP address] [destination MAC address]”. The value 3333.3333.3333 of the MAC address of the entry created for the ARP table 17 is set in [destination MAC address].

The CLI, created in the specific example, for adding an entry in the routing table of the switch 2 is “#ip route 202.0.0.0/24 201.0.0.101 e1”. The CLI for adding an entry in the ARP table of the switch 2 is “#arp 201.0.0.101 3333.3333.3333”. Entries as illustrated in FIG. 15 are added to the routing table and the ARP table of the switch 2 by these CLIs.

Additionally, in the specific example, a case of adding an entry is described, but the flow entry to be notified by the controller 3 in the case of deletion of an entry is the same as in the case of addition, but for the command included in FlowMod being “delete”. The CLI for the case of deleting an entry is “#no ip route [destination IP address] [next hop IP address] [output port]”, for example. The CLI for deleting an entry in the ARP table is “#no arp [next hop IP address] [destination MAC address]”, for example. The CLI/OF control unit 13 creates CLIs for deleting the deletion target entries in the ARP table 17 and the routing table 18. Additionally, the CLIs are different depending on the manufacturer or the like of the switch 2, and are not limited to those illustrated in FIG. 15.

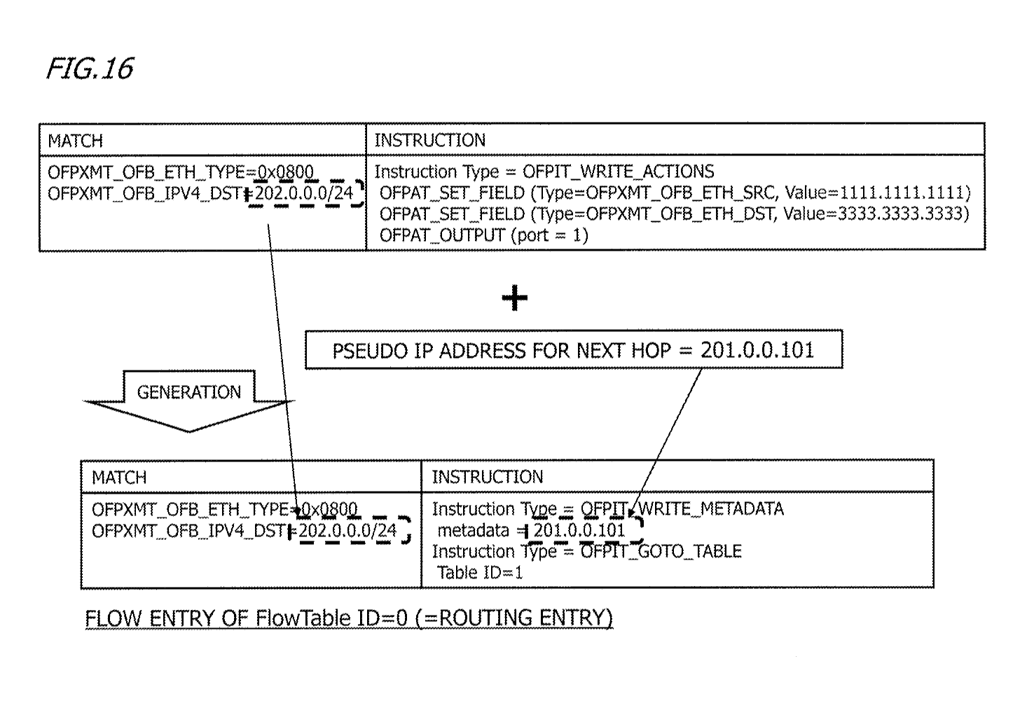

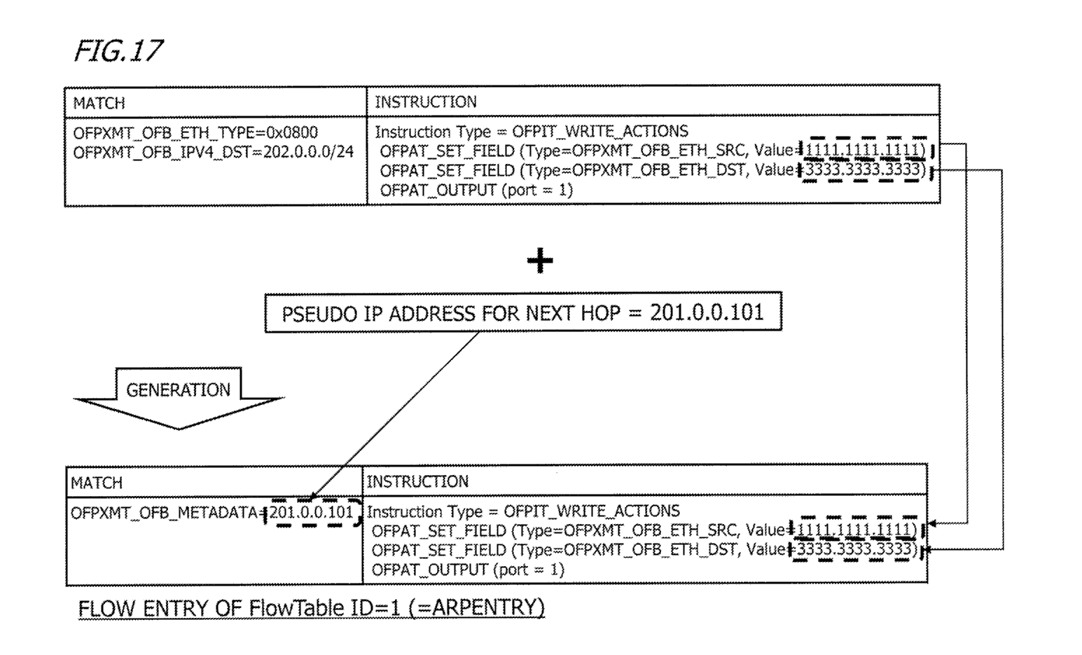

FIG. 16 is a diagram illustrating an example of a flow entry creating process for adding an entry in the routing table, for a case where the switch 2 supports OpenFlow but is not compatible with the format of a flow entry of the controller 3. FIG. 17 is a diagram illustrating an example of a flow entry creating process for adding an entry in the ARP table, for a case where the switch 2 supports OpenFlow but is not compatible with the format of a flow entry of the controller 3.

The CLI/OF control unit 13 holds the format of a flow entry that can be controlled by the switch 2, and a flow entry that can be controlled by the switch 2 is created by setting a value in a predetermined position in the format of the flow entry.

FIG. 16 illustrates a flow entry, corresponding to an entry in the routing table 18, to be notified to the switch 2. The address 202.0.0.0/24, which is [destination address] in “OFPXMT_OFB_IPV4_DST=202.0.0.0/24” in “Match” of the flow entry to be notified to the switch 2, is acquired from “OFPXMT_OFB_IPV4_DST=202.0.0.0/24” in “Match” of the flow entry notified by the controller 3. The address 201.0.0.101, which is [next hop IP address] in “metadata=201.0.0.101” in “Instruction” is acquired from the pseudo IP address.

FIG. 17 illustrates a flow entry, corresponding to an entry in the ARP table 17, to be notified to the switch 2. The address 201.0.0.101, which is [next hop IP address] in “OFPXMT_OFB_METADATA=201.0.0.101” in “Match” in the flow entry to be notified to the switch 2, is acquired from the pseudo IP address. The address 1111.1111.1111, which is [own MAC address] in “OFPAT_SET_FIELD(Type=OFPXMT_OFB_ETH_SRC, Value=1111.1111.1111)” in “Instruction” is acquired from “OFPAT SET FIELD(Type=OFPXMT_OFB_ETH_SRC, Value=1111.1111.1111)” in “Instruction” in the flow entry notified by the controller 3. The address 3333.3333.3333, which is [destination MAC address] in “OFPAT_SET_FIELD(Type=OFPXMT_OFB_ETH_DST, Value=3333.3333.3333)” in “Instruction”, is acquired from “OFPAT_SET_FIELD(Type=OFPXMT_OFB_ETH_DST, Value=3333.3333.3333)” in “Instruction” in the flow entry notified by the controller 3.

Additionally, in the case of deleting flow entries, the CLI/OF control unit 13 creates flow entries to be notified to the switch 2, based on the entries in the routing table 18 and the ARP table 17 corresponding to the deletion target flow entry. The flow entries to be created are the same as those illustrated in FIGS. 16 and 17, and the command in FlowMod is “delete”.

### Effects of First Embodiment

In the first embodiment, the OF agent 1 converts, for the switch 2 which is not compatible with the format of a flow entry of the controller 3, an instruction for adding a flow entry to an instruction for adding a CLI or a flow entry that can be controlled by the switch 2. At the time of conversion, the OF agent 1 generates in a pseudo manner a next hop IP address that serves as a link between the routing table and the ARP table. This allows the switch 2 which is not compatible with the format of a flow entry of the controller 3 to perform a forwarding process specified by the controller 3, and the switch 2 which is not compatible with the format of a flow entry of the controller 3 may be placed under control of the controller 3.

The OF agent 1 pools, as an IP address for a pseudo IP address, IP addresses which are not assigned to any device. This may suppress redundant use of IP address.

Furthermore, the OF agent 1 holds the ARP table 17, the routing table 18, and the flow table 19, and may cope with a flow entry deletion instruction from the controller 3.

According to the conversion apparatus and the conversion method of the disclosure, a switch which is not compatible with the format of packet forwarding information from a controller can be controlled by the controller.

### Others

In the first embodiment, the OF agent 1 is described as a single device. The OF agent 1 may be software, and may be installed in the switch 2, for example. That is, the processes to be performed by the OF agent 1 in the first embodiment may be performed by the switch 2 itself.

Furthermore, in the first embodiment, the OF agent 1 is connected to the switch 2 in a one-to-one manner, but the OF agent 1 and the switch 2 may be connected in a one-to-many manner. In the case where the OF agent 1 is connected to a plurality of switches 2, the OF agent 1 includes the pseudo IP address table 16, the ARP table 17, the routing table 18, and the flow table 19 for each switch 2. Also, the OF agent 1 holds CLIs or formats of a flow entry that can be controlled by respective switches 2.

### Recording Medium

A program for causing a computer, other machines or devices (hereinafter “computer or the like”) to achieve one of the functions described above may be recorded in a recording medium that can be read by the computer or the like. A function may be provided by causing the computer or the like to read and execute the program in the recording medium.

The recording medium that can be read by the computer or the like refers to a non-transitory recording medium that accumulates information such as data and programs electrically, magnetically, optically, mechanically or by chemical action and that can be read by the computer or the like. Among such recording mediums, those that can be removed from the computer or the like include a flexible disc, a magneto-optic disc, a CD-ROM, a CD-R/W, a DVD, a Blu-ray disc, a DAT, an 8 mm tape, a memory card such as a flash memory, and the like. Also, a hard disc, a ROM (Read Only Memory), and the like may be cited as the recording mediums fixed in the computer or the like. Moreover, an SSD (Solid State Drive) may be used as a recording medium that can be removed from the computer or the like, and as a recording medium that is fixed in the computer or the like.

All examples and conditional language provided herein are intended for the pedagogical purposes of aiding the reader in understanding the invention and the concepts contributed by the inventor to further the art, and are to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A conversion apparatus comprising:
an acquiring circuit configured to acquire a pseudo IP address to be used as a next hop IP address, when a first instruction for addition of packet forwarding information including, as a packet forwarding destination, a destination IP address and a destination MAC address is received, wherein the first instruction is being transmitted from a controller to a switch and wherein the switch is configured to perform forwarding a packet based on an association between an IP address and a next hop IP address, and an association between an IP address and a MAC address,
a generating circuit configured to generate a first association between the destination IP address and the pseudo IP address, and a second association between the pseudo IP address and the destination MAC address, and
an interface configured to transmit to the switch a second instruction for addition of the first association and the second association.

2. The conversion apparatus according to claim 1, further comprising a storage configured to store an IP address that is usable as the pseudo IP address,
wherein the acquiring circuit is configured to select the pseudo IP address from unused IP addresses among IP addresses stored in the storage.

3. The conversion apparatus according to claim 1, wherein the generating circuit is configured to
store the first association in a first storage,
store the second association in a second storage, and
generate a third instruction for deletion of the first association and the second association based on the first association and the second association, when a forth instruction for deletion of the packet forwarding information is received, wherein the forth instruction is transmitted from the controller to the switch, and
the interface is configured to transmit to the switch the third instruction.

4. The conversion apparatus according to claim 3, wherein the generating circuit is configured to generate the third instruction for deletion of the first association, and does not generate the third instruction for deletion of the second association, when the forth instruction is received and an association between the pseudo IP address and an IP address different from the destination IP address is stored in the first storage, and
the interface is configured to transmit the third instruction to the switch.

5. A conversion method for causing a computer to:
acquire a pseudo IP address to be used as a next hop IP address, when a first instruction for addition of packet forwarding information including, as a packet forwarding destination, a destination IP address and a destination MAC address is received, wherein the first instruction is being transmitted from a controller to a switch, and wherein the switch is configured to perform forwarding a packet based on an association between an IP address and a next hop IP address, and an association between an IP address and a MAC address,
generate a first association between the destination IP address and the pseudo IP address, and a second association between the pseudo IP address and the destination MAC address, and
transmit to the switch a second instruction for addition of the first association and the second association.
